(19) United States
(12) Patent Application Publication
(10) Pub. No.: US 2015/0009509 A1
(43) Pub. Date: Jan. 8, 2015

(54) TRANSPARENT SUBSTRATE MONITORING APPARATUS AND TRANSPARENT SUBSTRATE METHOD

(71) Applicant: Korea Research Institute of Standards and Science, Daejeon (KR)

(72) Inventors: Jae-Wan KIM, Daejeon (KR); Jong-Ahn KIM, Daejeon (KR); Jong-Han JIN, Daejeon (KR); Chu-Shik KANG, Daejeon (KR); Tae-Bong EOM, Daejeon (KR)

(21) Appl. No.: 14/491,589

(22) Filed: Sep. 19, 2014

Related U.S. Application Data
(63) Continuation of application No. PCT/KR2013/002175, filed on Mar. 18, 2013.

(30) Foreign Application Priority Data
Mar. 21, 2012 (KR) 10-2012-0028938
Jan. 28, 2013 (KR) 10-2013-0009059
Mar. 12, 2013 (KR) 10-2013-0025964

(51) Int. Cl. G01B 11/06

(52) U.S. Cl. CPC G01B 11/0691
USPC 356/503; 356/632

(57) ABSTRACT

Provided are a transparent substrate monitoring apparatus and a transparent substrate monitoring method. The transparent substrate monitoring apparatus includes a light emitting unit emitting light; a double slit disposed on a plane defined in a first direction and a second direction intersecting a propagation direction of incident light and includes a first slit and a second slit spaced apart from each other in the first direction to allow the light to pass therethrough; an optical detection unit measuring an intensity profile or position of an interference pattern formed on a screen plane; and a signal processing unit receiving a signal from the optical detection unit to calculate an optical phase difference or an optical path difference.

### CROSS-REFERENCE TO RELATED APPLICATIONS

This application is a continuation of and claims priority to PCT/KR2013/002175 filed on Mar. 18, 2013, which claims priority to Korea Patent Application No. 10-2012-0028938 filed on Mar. 21, 2012, Korea Patent Application No. 10-2013-0009059 filed on Jan. 28, 2013, and Korea Patent Application No. 10-2013-0025964 filed on Mar. 12, 2013, the entirety of which is hereby incorporated by reference.

### BACKGROUND

1. Technical Field

The present invention relates to thickness variation measuring apparatuses and thickness variation measuring methods and, more particularly, to a thickness variation measuring apparatus and a thickness variation measuring method capable of precisely measuring thickness variation using a double slit.

The present invention also relates to transparent substrate monitoring apparatuses and transparent substrate monitoring methods and, more particularly, to a transparent substrate monitoring apparatus and a transparent substrate monitoring method capable of precisely monitoring variation of an optical path difference using a double slit.

2. Description of the Related Art

Substrates made of glass or the like are used in flat panel display devices such as liquid crystal display (LCD) or organic light emitting diode (OLED) display device. With the recent trend toward larger-area and higher-resolution display devices, substrates included in the display devices become larger in area. Such non-uniformity of substrate thickness may have a negative influence on the image quality of display devices. Therefore, it is important to maintain uniform thickness throughout the entire surface of a substrate.

In general, a reflection-type thickness measuring apparatus is used to measure thickness variation of several nanometers (nm) to tens of nanometers (nm). The reflection-type thickness measuring apparatus employs interference between lights reflected from a front surface and a back surface of a substrate. However, a large area of a substrate may cause the substrate to warp during thickness measurement of the substrate. According to the warpage degree of the substrate, a path of the light reflected from the substrate is changed to make it difficult to precisely measure the substrate thickness.

### SUMMARY

Embodiments of the present invention provide a thickness variation measuring apparatus and a thickness variation measuring device which are capable of precisely measuring thickness variation of a measurement target by using a double slit.

Embodiments of the present invention also provide a transparent substrate monitoring apparatus and a transparent substrate monitoring method which measure an optical phase difference using a double slit and provide a spatial distribution of the optical phase difference by moving a transparent substrate by an interval of the double slit in a direction of the double slit and connecting all measuring positions.

A transparent substrate monitoring apparatus according to an embodiment of the present invention may include a light emitting unit emitting light; a double slit disposed on a plane defined in a first direction and a second direction intersecting a propagation direction of incident light and includes a first slit and a second slit spaced apart from each other in the first direction to allow the light to pass therethrough; an optical detection unit measuring an intensity profile or position of an interference pattern formed on a screen plane by first light transmitting a first position of a transparent substrate disposed between the light emitting unit and the double slit and passing through the first slit and second light transmitting a second position of the transparent substrate and passing through the second slit; and a signal processing unit receiving a signal from the optical detection unit to calculate an optical phase difference or an optical path difference of light rays passing through the first position and the second position of the transparent substrate. In an embodiment of the present invention, the signal processing unit may calculate the optical path difference using a position of the interference pattern in the first direction.

In an embodiment of the present invention, the transparent substrate which moves in the first direction is a glass substrate.

In an embodiment of the present invention, the optical detection unit may include a position sensitive detector. The transparent substrate monitoring apparatus may further include an aperture disposed in front of the optical detection unit to allow a principal maximum pattern of the interference pattern to pass therethrough. The position sensitive detector may output a center position of the principal maximum pattern.

In an embodiment of the present invention, the transparent substrate monitoring apparatus may further include a first aperture and a second aperture disposed in front of the optical detection unit and spaced apart from each other in the first direction. The optical detection unit may include a first optical detection unit disposed behind the first aperture and a second detection unit disposed behind the second aperture. An interval between the first aperture and the second aperture may be smaller than width of the principal maximum pattern.

In an embodiment of the present invention, the transparent substrate monitoring apparatus may further include an aperture disposed in front of the optical detection unit. The optical detection unit may include an optical sensor array disposed behind the aperture and arranged in the first direction.

In an embodiment of the present invention, the transparent substrate monitoring apparatus may further include a lens unit disposed between the double slit and the optical detection unit. The optical detection unit may be disposed at a focal point of the lens unit.

In an embodiment of the present invention, the light emitting unit may include a light source; and a reflection member changing an optical path of output light of the light source and providing the optical-path-changed light to the double slit.

In an embodiment of the present invention, the light emitting unit may include a light source; an optical fiber receiving output light of the light source; and a collimation lens converting light output from the optical fiber to collimated light and providing the collimated light to the double slit.

In an embodiment of the present invention, the light emitting unit may include a first light source irradiating light of first wavelength; a second light source irradiating light of second wavelength differing from the first wavelength; a directional coupler coupling an optical path of the first light source with an optical path of the second light source; and a collimation lens providing output light of the directional coupler to the double slit.

In an embodiment of the present invention, the first light source and the second light source may operate in a pulse mode. The first light source and the second light source may sequentially provide output lights to the double slit.

A transparent substrate monitoring method according to an embodiment of the present invention may include providing a double slit disposed on a plane defined in a first direction and a second direction intersecting a propagation of incident light and including a first slit and a second slit spaced apart from each other in the first direction to allow the light to pass therethrough; forming a first interference pattern by letting light of first wavelength with coherency successively pass through a transparent substrate and the double slit; measuring the position of the first interference pattern formed on a screen plane by first light transmitting a first position of a transparent substrate disposed in front of the double slit and passing through the first slit and second light transmitting a second position of the transparent substrate and passing through the second slit; and measuring a first phase difference caused by the transparent substrate by analyzing the position of the first interference pattern with the light of first wavelength.

In an embodiment of the present invention, the transparent substrate monitoring method may further include moving the transparent substrate by the slit interval of the double slit in the direction of the slit separation.

In an embodiment of the present invention, the transparent substrate monitoring method may further include calculating a spatial distribution of a first accumulated phase difference of the transparent substrate by summing the first phase differences measured at previous positions.

In an embodiment of the present invention, the transparent substrate monitoring method may further include forming a second interference pattern by letting light of second wavelength with coherency successively pass through the transparent substrate and the double slit; measuring a second phase difference caused by the transparent substrate by measuring the position of the second pattern with the light of second wavelength; and extracting a refractive index difference and a thickness difference between the first position and the second position of the transparent substrate using the first phase difference and the second phase difference.

In an embodiment of the present invention, the transparent substrate monitoring method may further include moving the transparent substrate by a slit interval of the double slit in a direction of the slit separation.

In an embodiment of the present invention, the transparent substrate monitoring method may further include extracting a spatial distribution of refractive index difference by summing the refractive index differences measured at previous positions and extracting a spatial distribution of thickness difference by summing the thickness differences measured at the previous positions.

In an embodiment of the present invention, the transparent substrate monitoring method may further include mounting a lens behind the double slit to have a focal point on the screen plane.

In an embodiment of the present invention, the transparent substrate monitoring method may further include providing an aperture on the screen plane to allow only a principal maximum pattern among the first interference pattern to pass therethrough.

An optical phase difference measuring apparatus according to an embodiment of the present invention may include a light emitting unit emitting light; a double slit disposed on a plane defined in a first direction and a second direction intersecting a propagation of incident light and including a first slit and a second slit spaced apart from each other in the first direction to allow the light to pass therethrough; an optical detection unit measuring an intensity profile or position of interference pattern formed on a screen plane by first light transmitting a first position of a measurement target disposed between the light emitting unit and the double slit and passing through the first slit and second light transmitting a second position of the measurement target and passing through the second slit; and a signal processing unit receiving a signal from the optical detection unit to calculate an optical phase difference of light rays passing through the first position and the second position of the transparent substrate.

A thickness variation measuring apparatus according to an embodiment of the present invention may include a light emitting unit emitting light; a double slit including a first opening and a second opening spaced apart from each other in a direction intersecting a propagation direction of the light; a measurement target disposed between the light emitting unit and the double slit to allow light to pass therethrough; an optical position detection unit receiving interference light generated by lights passing through the first opening and the second opening to detect position variation of an interference pattern; and a signal processing unit receiving a signal from the optical position detection unit to calculate thickness variation of the measurement target.

In an embodiment of the present invention, the intensity of the interference light may vary depending on a difference between a thickness of a first region corresponding to the first opening of the measurement target and a thickness of a second region corresponding to the second opening of the measurement target.

In an embodiment of the present invention, the thickness variation measuring apparatus may further include a movement control unit moving the measurement target in a direction intersecting a propagation direction of the light emitted from the light emitting unit.

In an embodiment of the present invention, the thickness variation measuring apparatus may further include a positive lens disposed between the double slit and the optical position detection unit.

In an embodiment of the present invention, the thickness variation measuring apparatus may further include an optical member that is disposed between the light emitting unit and the measurement target and converts the light emitted from the light emitting unit to parallel light.

In an embodiment of the present invention, the optical position detection unit may include a first optical detector and a second optical detector. The first optical detector and the second optical detector may be disposed in a direction intersecting a propagation direction of light to be spaced by the same distance from a position where the intensity of the interference light is maximum.

A thickness variation measuring method according to an embodiment of the present invention may include disposing a measurement target transmitting light and a double slit allowing light to pass therethrough and including a first opening and a second opening spaced apart from each other; irradiating light to successively pass through the measurement target and the double slit; and letting an optical position detection unit receive interference light generated by lights passing the first and second openings; and receiving a signal from the optical position detection unit to calculate thickness variation of the measurement target.

In an embodiment of the present invention, the measurement target may move in a direction intersecting a propagation direction of the light emitted from the light emitting unit.

In an embodiment of the present invention, a positive lens may be disposed between the double slit and the optical position detection unit to focus light passing through the double slit.

In an embodiment of the present invention, an optical member is disposed between the light emitting unit and the measurement target to convert the light emitted from the light emitting unit to parallel light.

In an embodiment of the present invention, letting an optical position detection unit receive interference light may include receiving the interference light by the optical position detection unit including a first optical detector and a second optical detector that is disposed in a direction intersecting a propagation direction of light to be spaced by the same distance from a position where the intensity of the interference light is maximum.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the present invention.

FIG. 1 is a perspective view of a thickness variation measuring apparatus concerning an embodiment of the present invention.

FIG. 2 is a graph illustrating an interference pattern of light passing through a double slit.

FIG. 3 is a graph illustrating intensity variation of interference light by expanding an A region in FIG. 2.

FIG. 4 is a graph illustrating signal variation depending on a phase difference in the thickness variation measuring apparatus in FIG. 1.

FIG. 5 is a flowchart illustrating the steps of a thickness variation measuring method using a thickness variation measuring apparatus according to the embodiment in FIG. 1.

FIG. 6A illustrates a transparent substrate monitoring apparatus according to an embodiment of the present invention.

FIG. 6B is a perspective view of the transparent substrate monitoring apparatus in FIG. 6A.

FIG. 7A illustrates an interference pattern when there is a phase difference in the transparent substrate monitoring apparatus in FIG. 6.

FIG. 7B shows the movement amount of an interference pattern depending on time.

FIG. 7C shows the movement amount of an interference pattern depending on time as optical phase differences depending on positions.

FIG. 7D shows a result of summing the optical phase differences in FIG. 7C.

FIG. 8 illustrates a transparent substrate monitoring apparatus according to another embodiment of the present invention.

FIG. 9 a transparent substrate process monitoring apparatus according to further another embodiment of the present invention.

FIG. 10 a transparent substrate monitoring apparatus according to still another embodiment of the present invention.

FIG. 11 is a timing diagram of the transparent substrate monitoring apparatus in FIG. 10.

FIG. 12 illustrates a transparent substrate process monitoring method according to an embodiment of the present invention.

FIG. 13 shows a result obtained using the method in FIG. 12.

FIG. 14 is a flowchart illustrating a transparent substrate monitoring method according to an embodiment of the present invention.

FIG. 15 is a flowchart illustrating a transparent substrate monitoring method according to another embodiment of the present invention.

FIG. 16 is a graph showing an optical path difference measuring result according to an embodiment of the present invention.

### DETAILED DESCRIPTION

According to an embodiment of the present invention, if a transparent substrate has a non-uniform thickness, an optical path length of light passing the transparent substrate varies. Thus, a phase difference of light passing through a glass occurs at respective positions. In order to measure a phase difference, beam emitted from a light source is converted to parallel light and passes through the transparent substrate. The beam passing through the transparent substrate impinges on a double slit having a slit interval “a”. The light passing through the double slit is diffracted to form an interference fringe on a screen plane on which an optical detection unit is disposed. There is no phase difference caused by each optical path of the double slit, and a maximum peak of the interference fringe is disposed in the center of the double slit. If a phase difference caused by each optical path of the double slit occurs, the maximum peak of the interference fringe disposed in the center of the double slit moves vertically in the x-axis direction that is a slit interval direction. Thus, if the optical detection unit is used to measure how the position of a peak point of the interference fringe changes, it is possible to know a thickness difference at two positions of the transparent substrate.

In addition, the optical path difference measured using the double slit is expressed by multiplication of a refractive index and a thickness (or distance). Additional measurement is required to separate information on the refractive index and the thickness from the optical path difference. If an optical path difference of the same position is measured at difference two wavelengths, a thickness difference and a refractive index difference may be obtained.

The present invention will now be described more fully hereinafter with reference to the accompanying drawings, in which preferred embodiments of the present invention are shown. However, the present invention may be embodied in many different forms and should not be construed as limited to the embodiments set forth herein. Rather, these embodiments are provided so that this disclosure will be thorough and complete, and will fully convey the scope of the present invention to those skilled in the art. In the drawings, elements or components are exaggerated for clarity. Like numbers refer to like elements throughout.

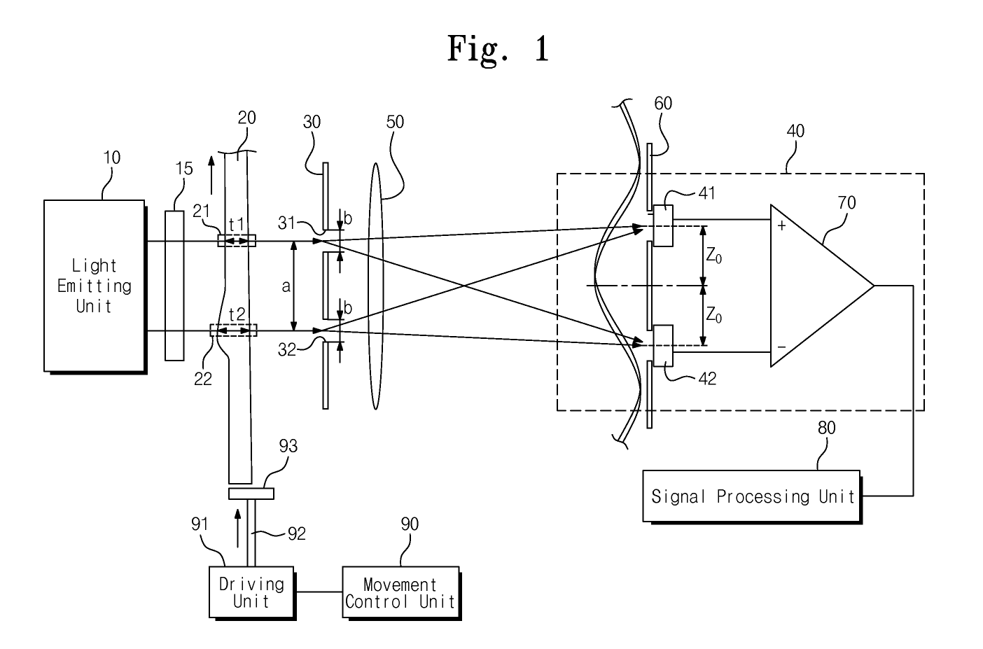

FIG. 1 is a perspective view of a thickness variation measuring apparatus concerning an embodiment of the present invention.

As shown in FIG. 1, the thickness variation measuring apparatus concerning an embodiment of the present invention includes a light emitting unit 10 irradiating light, a double slit 30 having a first opening 31 and a second opening 32 through which the light radiated from the light emitting unit 10 passes, an object to be measured (hereinafter referred to as “measurement target”) 20 disposed between the light emitting unit 10 and the double slit to allow light to be transmitted, an optical position detection unit 40 receiving interference light generated by the light passing through the double slit 30 to generate a signal, and a signal processing unit 80 receiving the signal of the optical position detection unit 40 to calculate thickness variation of the measurement target 20.

The light emitting unit 10 emits light to measure thickness variation of the measurement target 20. The light has coherence. The light emitting unit 10 may be implemented as a laser light source. The light emitting unit 10 may be laser lasing at a single wavelength or two lasers lasing at two different wavelengths.

The double slit 30 extends in a direction intersecting a direction in which the light emitted from the light emitting unit 10 propagates. The double slit 30 has the first opening 31 and the second opening 32, which are spaced apart from each other in the direction intersecting the direction in which the light emitted from the light emitting unit 10 propagates, allowing the light to be transmitted.

The measurement target 20 is disposed between the double slit 30 and the light emitting unit 10. The measurement target 20 is a light transparent material through which the light emitted from the light emitting unit 10 can pass.

An optical member 15 may be disposed between the light emitting unit 10 and the measurement target 20. The optical member 15 may be a collimator converting the light emitted from the light emitting unit 10 to parallel light and include two positive lenses of different focal lengths.

The light emitted from the light emitting unit 10 passes through the measurement target 20. After passing through the measurement target 20, the light passes through the respective openings 31 and 32. The light is diffracted while passing through the respective openings 31 and 32. The diffracted lights are combined with each other to generate interference light.

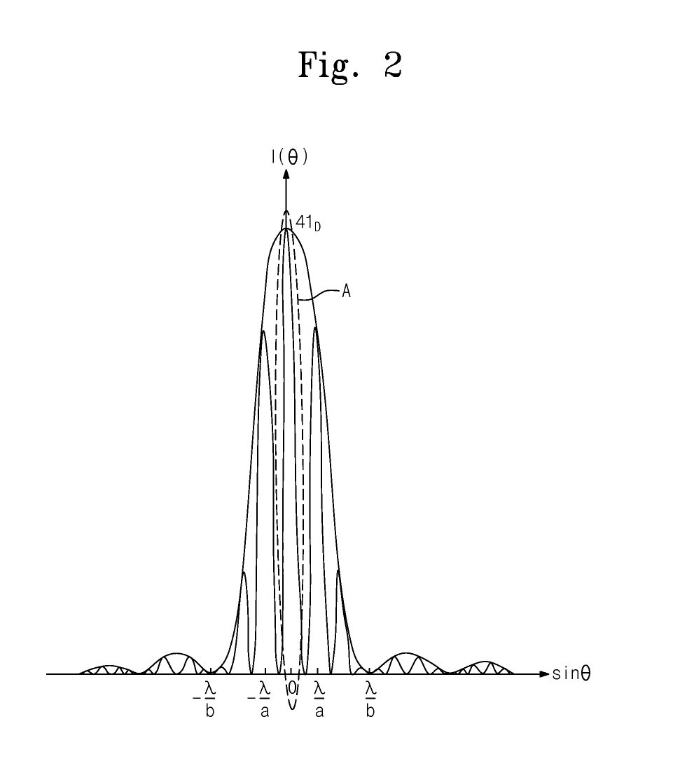

A predetermined interference pattern shown in FIG. 2 is formed on a virtual screen surface 60 disposed to be spaced apart from the double slit 30. One or more of the interference patterns is selected to measure the movement amount of the interference pattern when the measurement target 20 moves. The optical position detection unit 40 is disposed on the virtual screen surface 60 and collects interference light to measure the position variation amount of an interference signal. The optical position detection unit 40 includes a first optical detector 41 and a second optical detector 42. The first optical detector 41 and the second optical detector 42 are disposed to be spaced at the same distance from the maximum intensity position of the interference light in a direction intersecting the light propagation direction by selecting one of the interference patterns generated by the light passing through the first opening 31 and the second opening 32 under the state that the measurement target 20 does not exist.

The optical position detection unit 40 may include a plurality of photodiodes each having a front surface where an aperture is formed.

However, the present invention is not limited thereto, and the optical position detection unit 40 may include a photodiode array or a charge-coupled diode (CCD).

The positive lens 50 may be disposed between the double slit 30 and the optical position detection unit 40, and the optical position detection unit 40 may be disposed in a region corresponding to the focal length of the positive lens 50.

The measurement target 20 may be disposed to be movable between the light emitting unit 10 and the double slit 30 in a direction intersecting the propagation direction of the light emitted from the light emitting unit 10. The measurement target 20 is pressurized by a pressing member 93 coupled to the end of a cylinder 92 that is flexibly moved by a driving member 91. Thus, the measurement target 20 may move in the direction intersecting the light propagation direction of the light emitting unit 10.

The driving member 91 may be electrically connected to a movement control unit 90 and be operated by a control signal applied from the movement control unit 90 to allow the measurement target 20 to move at constant speed.

FIG. 2 is a graph illustrating an interference pattern of light passing through a double slit.

FIG. 2 shows an interference pattern formed on a virtual screen surface 60 when lights passing through the first opening 31 and the second opening 32 of the double slit 30 have the same phase because the measurement target 20 in FIG. 1 is removed or a thickness t1 of the first region of the measurement target 20 is equal to a thickness t2 of the second region of the measurement target 20.

In FIG. 2, θ represents an angle indicating a position of the interference pattern formed on the virtual screen surface 60 and corresponds to an angle deviating from a vertical line connecting the center of the double slit 30 with the screen 60. In the graph of FIG. 2, the light intensity I(θ) is expressed by an Equation (1) below. When θ is zero, the intensity of interference light is maximum.

The first optical detector 41 and the second optical detector 42 of the light position detection unit 40 are disposed to be spaced at the same distance from an intensity maximum position of the interference light where θ corresponds to 0 or π

$$I ( θ ) = 4 {I}_{0} ( \frac{{sin}^{2} β}{{β}^{2}} ) {cos}^{2} α \qquad Equation ( 1 )$$

In the Equation (1), I₀ represents an intensity of light emitted from a light source, α represents a value of the Equation (2) below, and β represents the Equation (3) below.

$$\begin{matrix}α = \frac{ka}{2} sin θ & Equation ( 2 ) \\ β = \frac{kb}{2} sin θ & Equation ( 3 )\end{matrix}$$

In the Equations (2) and (3), “a” represents a distance between the first opening 31 and the second opening 32 of the double slit 30, “b” represents width of each of the first opening 31 and the second opening 32 of the double slit 30, and “k” corresponds to 2π/λ (λ being a wavelength of light used).

The graph shown in FIG. 2 corresponds to a graph when lights passing through the first opening 31 and the second opening 32 of the double slit have the same phase. However, as shown in FIG. 1, when the measurement target 20 having different thicknesses t1 and t2 of the first region and the second region is disposed between the double slit 30 and the light emitting unit 10 to cause a phase difference between the lights passing through the first opening 31 and the second opening 32, the form of the interference pattern formed on the virtual screen surface 60 may be changed by interference light.

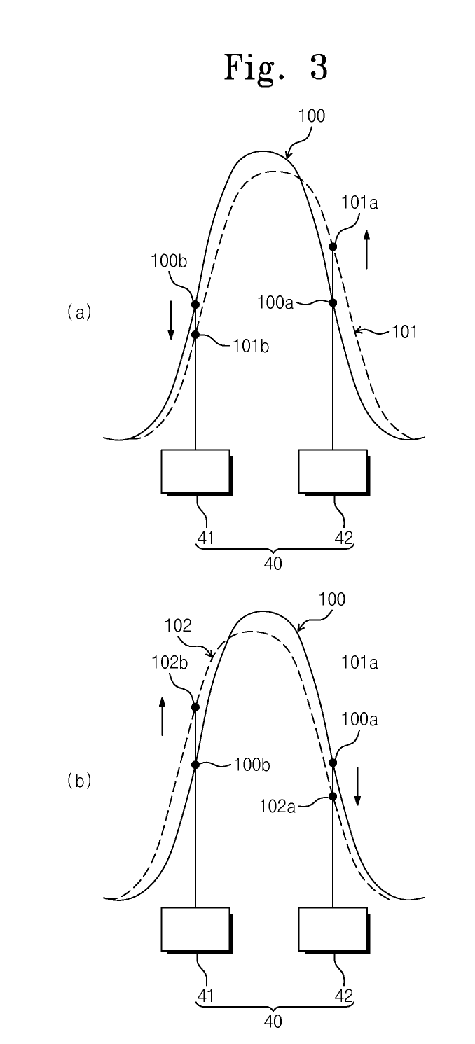

FIG. 3 is a graph illustrating intensity variation of interference light by expanding an A region in FIG. 2.

As shown in FIG. 1, a thickness t1 of a first region 21 of the measurement target 20 corresponding to the first opening 31 of the double slit 30 may be different from a thickness t2 of a second region 22 of the measurement target 20 corresponding to the second opening 32 of the double slit 30. In the case where the first region 21 and the second region 22 are different in thickness, phases of lights passing through the first opening 31 and the second opening 32 may be different from each other.

FIG. 3 illustrates interference pattern variation caused by a phase difference of light between the first opening 31 and the second opening 32.

The first optical detector 41 and the second optical detector 42 are disposed to be spaced at the same distance Z₀ from an intensity maximum position of interference light when there is no measurement target 20 or there is no phase difference between lights passing through the first opening 31 and the second opening 32 of the double slit 30. Thus, interference lights 100a and 100b of the same intensity impinge on the first optical detector 41 and the second optical detector 42 according to the interference pattern 100 when there is no phase difference between the lights passing through the first opening 31 and the second opening 32, respectively.

However, as shown in FIG. 3(a), if an interference pattern of diffracted light is converted to a right-moving pattern 101 due to variation of thickness of the measurement target 20, the intensity 101b of the interference light impinging on the first optical detector 41 is made smaller than the intensity 101a of the interference light impinging on the second optical detector 42.

In addition, as shown in FIG. 3(b), if an interference pattern of diffracted light is converted to a left-moving pattern 102 due to variation of thickness of the measurement target 20, the intensity 102b of the interference light impinging on the first optical detector 41 is made greater than the intensity 102a of the interference light impinging on the second optical detector 42.

When a phase difference between the lights at the first opening 31 and the second opening 32 is Ø₀, a signal indicating an electric field E of the interference lights at the first optical detector 41 and the second optical detector 42 may be expressed by the Equation (4) below.

$$\begin{matrix}E = bc ( \frac{sin ( β - \frac{b}{2 a} {φ}_{0} )}{β - \frac{b}{2 a} {φ}_{0}} ) [ \begin{matrix}sin ( ω t - kR ) + \\ sin ( ω t - kR + 2 α - {φ}_{0} )\end{matrix} ] \\ = 2 bc ( \frac{sin ( β - \frac{b}{2 a} {φ}_{0} )}{β - \frac{b}{2 a} {φ}_{0}} ) cos ( α - \frac{{φ}_{0}}{2} ) sin ( ω t - kR + α - \frac{{φ}_{0}}{2} )\end{matrix} \qquad Equation ( 4 )$$

In the Equation (4), Ø₀ represents a phase difference between lights reaching the first opening 31 and the second opening 32 in FIG. 1, “c” represents a constant considering reflection or loss, “R” represents a distance from the double slit 30 to the virtual screen surface 60, “ω” represents an angular frequency of light, “b” represents width of a slit, “k” represents the wave number of light, and “t” represents time. In FIG. 1, when the measurement target 20 is disposed to generate a phase difference between lights passing through the first opening 31 and the second opening 32 of the double slit 30, the intensity of interference light forming an interference pattern on the virtual screen surface 60 may be expressed by the Equation (5) below.

$$I ( θ ) = 4 {I}_{0} ( \frac{{sin}^{2} ( β - \frac{b}{2 a} {φ}_{0} )}{{( β - \frac{b}{2 a} {φ}_{0} )}^{2}} ) {cos}^{2} ( α - \frac{{φ}_{0}}{2} ) \qquad Equation ( 5 )$$

From the Equation (5), it will be understood that an interference pattern (fringe pattern) moves to the right or left with change of a value of Ø₀ that is a phase difference between lights reaching the first opening 31 and the second opening 32.

The Equation (6) below may be derived using the Equation (5) to obtain a signal difference between the first optical detector 41 and the second optical detector 42 according to the phase difference of the light at the first opening 31 and the second opening 32 of the double slit 30.

$$\begin{matrix}V ( {φ}_{0} ) = V ( θ , {φ}_{0} ) - V ( - θ , {φ}_{0} ) \\ = A \vert {cos}^{2} ( \frac{ka}{2} sin θ - \frac{{φ}_{0}}{2} ) - {cos}^{2} ( - \frac{ka}{2} sin θ - \frac{{φ}_{0}}{2} ) \vert\end{matrix} \qquad Equation ( 6 )$$

In the Equation (6), “A” represents an I-V conversion constant considering a gain of an optical detector.

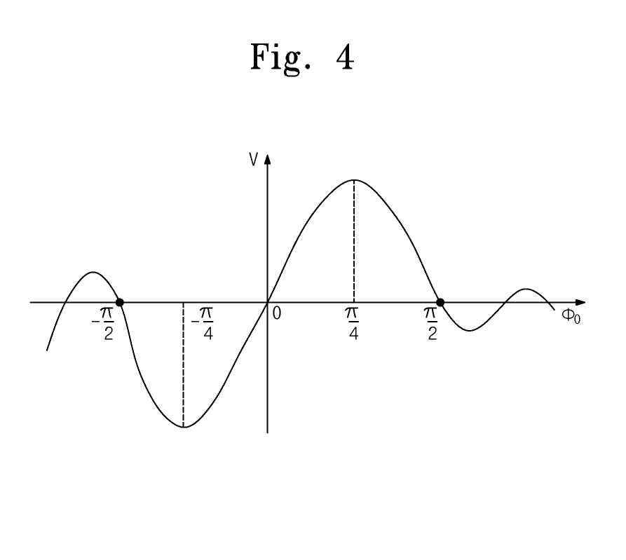

FIG. 4 is a graph illustrating signal variation depending on a phase difference in the thickness variation measuring apparatus in FIG. 1.

FIG. 4 shows a signal difference V(Ø₀) between the first optical detector 41 and the second optical detector 42 depending on a phase difference Ø₀ between the lights at the first opening 31 and the second opening 32 of the double slit 30.

When a signal difference between the first optical detector 41 and the second optical detector 42 is V and a phase difference between lights at the first opening 31 and the second opening 32 is Ø₀, a signal difference V(Ø₀) may be expressed by the Equation (7) below.

$$\begin{matrix}V ( {φ}_{0} ) = V ( θ , {φ}_{0} ) - V ( - θ , {φ}_{0} ) \\ \approx A [ {cos}^{2} ( \frac{ka}{2} \times \frac{{z}_{0}}{F} θ - \frac{{φ}_{0}}{2} ) - {cos}^{2} ( - \frac{ka}{2} \times \frac{{z}_{0}}{F} θ - \frac{{φ}_{0}}{2} ) ]\end{matrix} \qquad Equation ( 7 )$$

In the Equation (7), “a” represents distance of the first opening 31 and the second opening 32, “k” corresponds to 2π/λ (λ being a wavelength of light used), “Zo” corresponds to half a distance between the first optical detector 41 and the second optical detector 42, “F” represents a focal length of a lens, and “A” in the Equations (6) and (7) is equal to the Equation (8).

$$A = 4 {I}_{0} ( \frac{{sin}^{2} ( β - \frac{{φ}_{0}}{2} )}{{( β - \frac{{φ}_{0}}{2} )}^{2}} ) \qquad Equation ( 8 )$$

The phase difference Ø₀ of the lights at the first opening 31 and the second opening 32 may be calculated from a signal difference between the first optical detector 41 and the second optical detector 42. A difference between the thicknesses t1 and t2 of the first and second regions of the measurement target 20 may be calculated from the phase difference Ø₀.

Here, Ø₀ is 2(n−1)π/λ(t1−t2) and “n” represents a refractive index of a measurement target.

As shown in FIG. 1, when the signal of the first optical detector 41 and the signal of the second optical detector 42 are applied to the signal processing unit 80 through an amplifier 70, the signal processing unit 80 may calculate thickness variation of the measurement target 20. Thus, the signal processing unit 80 may process variation of the signal of the first optical detector 41 and the signal of the second optical detector 42 to precisely measure thickness variation of the measurement target 20. As a result, the pattern of thickness variation at a surface of the measurement target 20 may be understood.

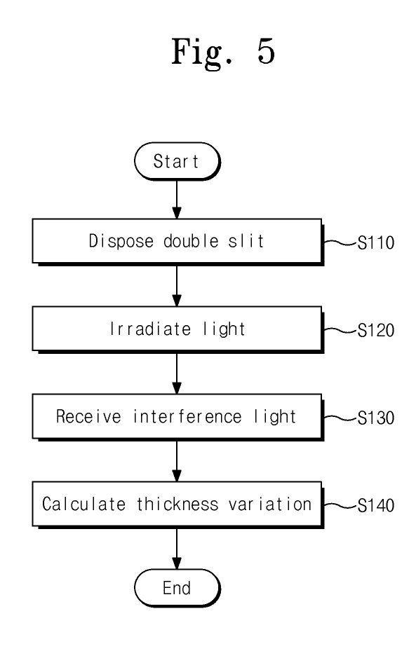

FIG. 5 is a flowchart illustrating the steps of a thickness variation measuring method using a thickness variation measuring apparatus according to the embodiment in FIG. 1.

The thickness variation measuring method illustrated in FIG. 1 includes disposing a measurement target and a double slit through which light passes (S110), sequentially irradiating light to the measurement target and the double slit (S120), receiving interference light passing through the double slit using a light position detection unit (S130), and calculating thickness variation of the measurement target by receiving a signal from the light position detection unit (S140). The steps S110 to S140 of the thickness variation measuring method may be performed by a computer that is connected to the light emitting unit 10, the signal processing unit 80, and the movement control unit 90 of the thickness variation measuring apparatus shown in FIG. 1 to control operations of respective elements. In addition, the steps S110 to S140 of the thickness variation measuring method may be recorded in a nonvolatile record medium after being written as programs that are executable on the computer, respectively.

A transparent substrate monitoring apparatus and a transparent substrate monitoring method according to an embodiment of the present invention will now be described below in detail.

A glass substrate is manufactured at a high temperature and cooled to remain in a solid state. A glass substrate or a plastic substrate is transferred by a driving member. The driving member may be a transfer roller. It is necessary to investigate physical properties such as a thickness and a refractive index of the glass substrate. In the case that a thin film or a contaminant is deposited on a transparent substrate or a glass substrate, a method for monitoring the transparent substrate is required.

The transparent substrate induces vibration while being transferred. Accordingly, a conventional monitoring method causes an error resulting from the vibration. There is a need for an apparatus and a method for monitoring characteristics of a transparent substrate in real time without occurrence of an error resulting from vibration of the transparent substrate.

According to an embodiment of the present invention, interference light passes through a transparent substrate. Thus, an error resulting from vibration of the transparent substrate may be suppressed.

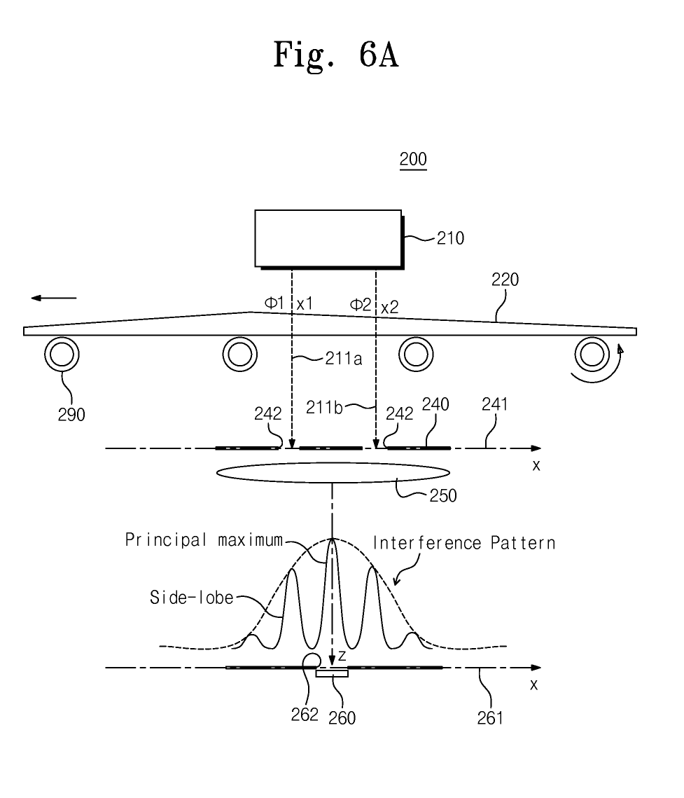

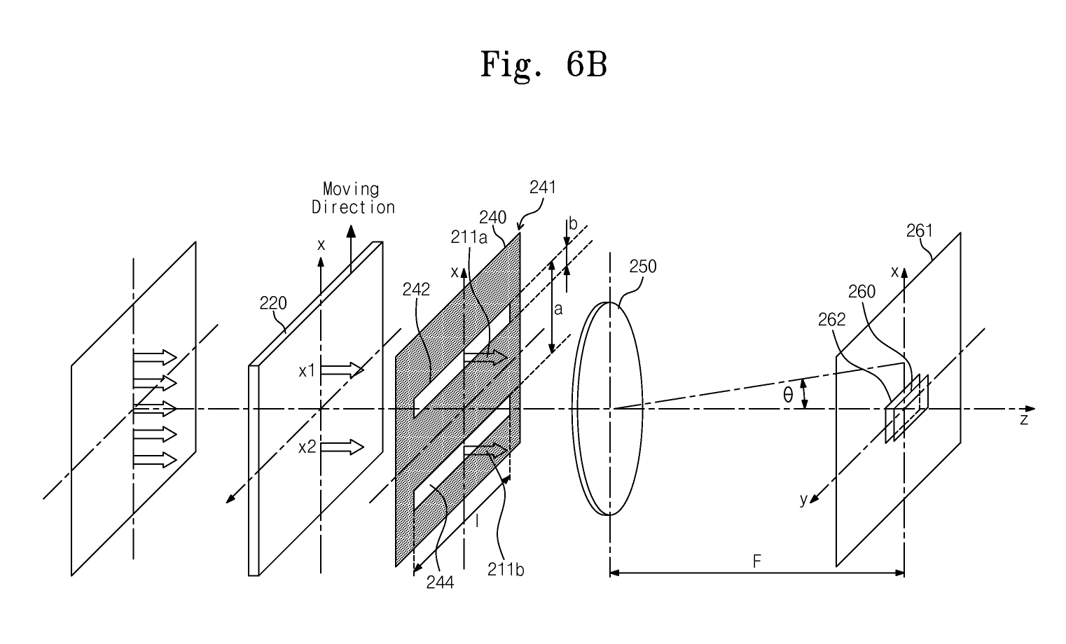

FIG. 6A illustrates a transparent substrate monitoring apparatus according to an embodiment of the present invention.

FIG. 6B is a perspective view of the transparent substrate monitoring apparatus in FIG. 6A.

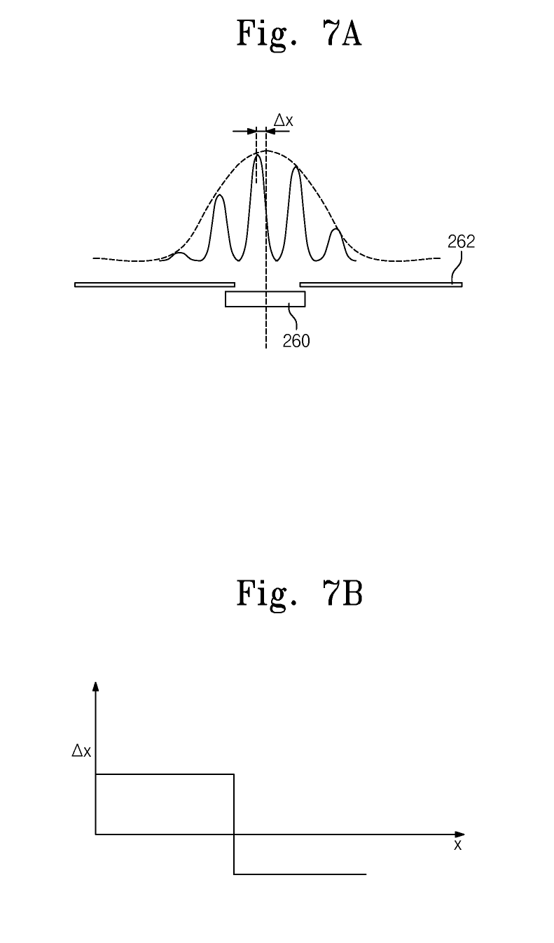

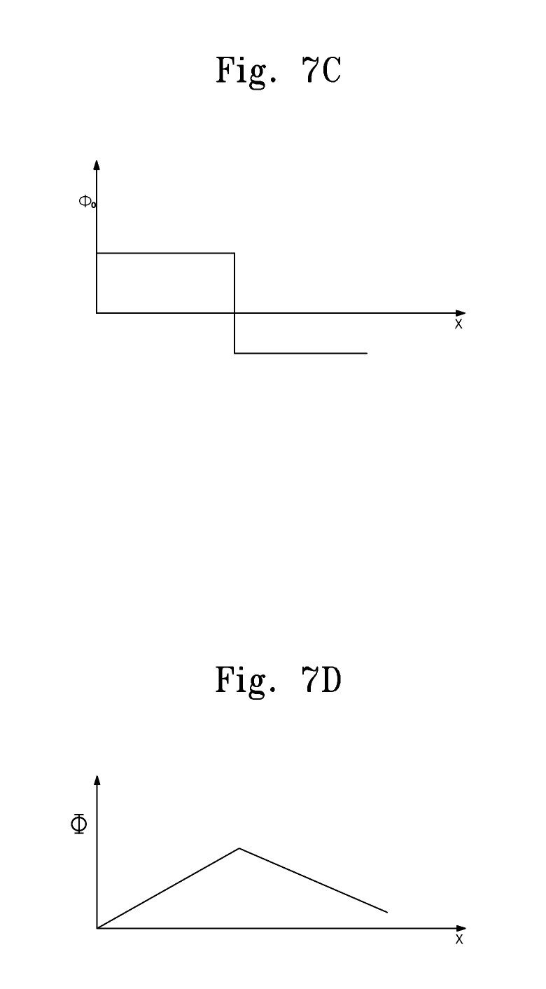

FIG. 7A illustrates an interference pattern when there is a phase difference in the transparent substrate monitoring apparatus in FIG. 6.

FIG. 7B shows the movement amount of an interference pattern depending on time.

FIG. 7C shows the movement amount of an interference pattern depending on time as optical phase differences depending on positions.

FIG. 7D shows a result of summing the optical phase differences in FIG. 7C.

Referring to FIGS. 6 and 7, a transparent substrate monitoring apparatus 200 according to an embodiment of the present invention includes a light emitting unit 210 emitting light, a double slit 240 disposed on a first plane (xy plane) 241 defined by a first direction (x-axis direction) and a second direction (y-axis direction) intersecting a propagation direction of the light (z-axis direction) and including a first slit 242 and a second slit 244 spaced apart from each other in the first direction to allow light to pass therethrough, an optical detection unit 260 measuring an interference pattern formed on a screen plane 261 by first light 211a transmitting a first position x1 of a transparent substrate 220 disposed between the light emitting unit 210 and the double slit 240 and passing through the first slit 240 and second light 211b transmitting a second position x2 of the transparent substrate 220 and passing through the second slit 244, and a signal processing unit (not shown) receiving a signal from the optical detection unit 260 to calculate an optical phase difference or an optical path difference resulting from the transparent substrate 220.

The light emitting unit 210 may be a light source having coherence. Specifically, the light source 210 may be laser, a laser diode or a light emitting diode (LED). A wavelength of the light emitting unit 210 may be a visible ray area or an infrared ray area. The wavelength of the light emitting unit 210 may be dependent on characteristics of a transparent substrate. For example, a silicon substrate may be transparent in the infrared area. A glass substrate may be transparent in the infrared area and the visible ray area.

The double slit 240 may receive parallel light. A collimation lens unit (not shown) may be disposed between the light emitting unit 210 and the double slit 240 to provide the collimated light to the double slit 240.

The double slit 240 may be disposed on a first plane (x-y plane) 241 orthogonal to a propagation direction of incident light (z-axis direction). The double slit 240 may be disposed on the first plane 241 and include the first slit 242 and the second slit 244. Each of the first and second slits 242 and 244 may be a strip line type slit. The first slit 242 and the second slit 244 may have constant width “b” and constant length “1”. The first slit 242 and the second slit 244 may have a constant interval “a”. The first slit 242 and the second slit 244 may be disposed to be spaced apart from each other in the x-axis direction, and the length direction of the first and second slits 242 and 244 may be the y-axis direction. The interval between the first and second slits 242 and 244 may be 0.1 millimeter or 0.05 millimeter. The slit width “b” may be 0.01 millimeter or 0.02 millimeter. The slit length “1” may be several millimeters.

First light passing through the first slit 242 may be diffracted, and second light passing through the second slit 244 may be diffracted. The first light and the second light may form an interference fringe on the screen plane 261. The double slit 240 allows light to pass through the first slit 242 and the second slit 244, but prevents the light from passing through another region. Thus, the first slit 242 and the second slit 244 of the double slit 240 may be through-hole type slits.

According to a modified embodiment of the present invention, the double slit 240 may have a structure coated with a material absorbing or reflecting light in a region except for a first slit and a second slit on a transparent substrate.

The transparent substrate 220 may be disposed between the light emitting unit 210 and the double slit 240. A disposed plane of the transparent substrate 220 may be an x-y plane. The transparent substrate 230 may be transferred in the x-axis direction at constant speed.

The transparent substrate 220 may be disposed alongside of the disposed plane of the double slit 240. The transparent substrate 220 may successively move in the x-axis direction in constant speed. The transparent substrate 220 may be a glass substrate, a plastic substrate, a silicon substrate, a sapphire substrate or a transparent film. The thickness of the transparent substrate 220 may range from tens of micrometers to tens of millimeters. A thin film, a pattern or a contaminant may be disposed on the transparent substrate 220.

A monitoring apparatus according to an embodiment of the present invention may measure a relative optical phase difference or a relative optical path difference of the transparent substrate. In addition, the monitoring apparatus may provide information on thin films and information on contaminants.

According to a modified embodiment of the present invention, the disposed plane of the transparent substrate and the disposed plane of the double slit may be not lined up with each other.

The lens unit 250 may be disposed between the optical detection unit 260 and the double slit 240. Preferably, the lens unit 250 may be disposed to lean to the double slit 240. The central axis of the double slit 240 and the central axis of the lens unit 250 may match each other. The lens unit 250 may be a convex lens of focal length F. The screen plane 261 may be disposed at the focal point of the lens unit 250. The optical detection unit 260 may be disposed on the screen plane 261. Since the double slit 240 is disposed to be spaced in the x-axis direction, an interference pattern may have a band shape in the x-axis direction.

The optical detection unit 260 detects an interference fringe formed by the double slit 240. The central axis of optical detection unit 260 may match the central axis of the lens unit 250 or the central axis of the double slit 240.

The interference fringe may be divided into a principal maximum pattern and a sidelobe pattern. The interference fringe may have a shape of band extending in the y-axis direction and may be disposed along the x-axis. Thus, the optical detection unit 260 may be an optical sensor array or a position sensitive detector disposed in the x-axis direction. The optical detection unit 260 may measure an intensity profile or position of the interference pattern.

The optical sensor array may be a charge coupled device (CCD) sensor, a CMOS image sensor (CIS) or a photodiode array. If the optical detection unit is an optical sensor array, an aperture disposed in front of the optical detection unit may be eliminated.

Alternatively, the optical detection unit 260 may detect the intensity distribution of a specific single pattern from the interference pattern. Alternatively, the optical detection unit 260 may detect the intensity of a pattern at a specific fixed position.

The position sensitive detector may be a semiconductor device measuring a position of an optical spot or a specific pattern. The position sensitive detector may be aligned in the x-axis direction and output a position of the point where the intensity of light is maximum. The position sensitive detector may be a one-dimensional or two-dimensional device.

The position sensitive detector may measure a position shift of a single pattern of the interference pattern. For example, the position sensitive detector may detect a central position of a principal maximum pattern having the maximum intensity. An aperture 262 removing a sidelobe pattern may be disposed in front of the optical detection unit 260 to detect only a principal maximum pattern from the interference pattern. Width of the aperture 262 may be equal to or greater than that of the principal maximum pattern. Length of the aperture 262 may be smaller than that of the double sit 240. The position sensitive detector may have a resolution less than several micrometers. Accordingly, an optical path difference or an optical phase difference may be determined.

Irradiance I on the screen plane may be given by the Equations (1) to (3) according to an angle θ defined by the central axis of a lens unit and a position of the x-axis on a predetermined screen surface. Here, “I₀” represents irradiance formed by a single slit, “a” represents a distance between slits, “b” represents width of a slit, and “k” represents wave number.

If there is no phase difference between first light 211a and second light 211b due to the transparent substrate 220, a center position of the principal maximum pattern may match the central axis of the lens unit 250.

When there is a relative phase difference Ø₀ between first light passing through a first slit and second light passing through a second slit, the irradiance on the screen plane may be given by the Equation (5) according to an angle θ defined by the central axis of a lens unit and a position of the x-axis on a predetermined screen plane.

That is, a maximum-point position or a minimum-point angle of an interference pattern relatively shifts by Ø₀ to (ka/2) sin θ on a screen plane. And an envelope of the interference pattern may be shifted.

If there is a phase difference Ø₀ between the first light 211a and the second light 211b due to the transparent substrate 220, the center position of the principal maximum pattern may deviate from the central axis of the lens unit 250 and shift by Δx in the x-axis direction. The shift amount Δx of the center position of the principal maximum pattern may depend on the relative optical phase difference Ø₀ of the first light 211a and the second light 211b. The shift amount Δx of the center position of the principal maximum pattern may be may be approximately given by the Equation (9) below.

Δx≈Fφ₀(x1,x2)/(ka) Equation (9)

In the Equation (9), “Ø₀(x1, x2)” represents a relative optical phase difference generated by a first position x1 and a second position x2, “F” represents a focal length of the lens unit 250, “a” represents a distance between the double slit, and “k” represents the wave number (k=2π/λ, λ being a wavelength of light emitted from the light emitting unit 210). That is, the shift amount Δx of the center position of the principal maximum pattern may correspond to the relative optical phase difference.

A signal processing unit receives an output signal of the optical detection unit 260 to calculate an optical phase difference or an optical path difference resulting from the transparent substrate 220.

Specifically, if the optical detection unit 260 is an optical sensor array, the optical detection unit 260 outputs spatial light intensity. Thus, the signal processing unit receives the spatial light intensity to recognize a pattern of the interference fringe. The signal processing unit may calculate a center position of a specific pattern of the interference fringe. When a center position of the specific pattern shifts, the signal processing unit may convert the shift amount of the center position to an optical phase difference.

If the optical detection unit 260 is a position sensitive detector, the position sensitive detector may directly output a center position of a principal maximum pattern. The signal processing unit receives an output signal of the optical detection unit 260 to calculate the shift amount Δx of the center position of the principal maximum pattern. Thus, the signal processing unit may calculate a phase difference Ø₀ of the first light and the second light.

According to a modified embodiment of the present invention, the optical detection unit 260 may be variously modified to measure.

If the phase difference Ø₀ between the first light and the second light is measured at a certain position of the transparent substrate, only a measured relative phase difference between a pair of positions is confirmed.

It is necessary to measure a spatial distribution of an optical phase difference on the basis of one reference position x1. In order to achieve this, a pair of positions for new measurement may include a single point among a previous measured pair of positions. That is, if a previous pair of positions are a first position x1 and a second position x2, a pair of positions for new measurement are the second position x2 and a new third position x3. Accordingly, successive measurement is performed while a transparent substrate is moving by the slit interval “a”. An accumulated optical phase difference Φ may be expressed by the sum of optical phase differences at previous measuring positions. Thus, a spatial distribution of the accumulated optical phase difference Φ to a reference position may be calculated.

The accumulated optical phase difference Φ may be given by the Equation (10) below.

Φ(xn)=[φ₀(x1,x2)]+[φ₀(x2,x3)] . . . +[φ₀(xn−1,xn)] Equation (10)

The accumulated optical phase difference Φ may be used for monitoring. That is, the accumulated optical phase difference Φ has one-to-one correspondence with an optical phase difference. The optical phase difference is a function of refractive index and thickness. Assuming that refractive index is constant, the spatial distribution of the accumulated optical phase difference Φ may indicate a spatial distribution of relative thickness. If the spatial distribution of the accumulated optical phase difference Φ exceeds a predetermined critical value, the transparent substrate may be treated as a bad one.

When there is locally a contaminant or a pattern on the transparent substrate, the accumulated optical phase difference Φ may be changed by the contaminant or the pattern. Thus, a contaminant-formed position may be confirmed. In addition, a relative thickness distribution of a thin film may be confirmed from a difference between a spatial distribution of an accumulated optical phase difference after formation of a thin film and a spatial distribution of an accumulated optical phase difference before formation of the thin film.

According to a modified embodiment of the present invention, an accumulated optical phase difference Φ may be measured with respect to positions while a deposition process or an etching process is performed on a moving transparent. Thus, real-time monitoring may be achieved.

Referring to FIGS. 7B to 7D, as the transparent substrate 220 moves in a positive direction of the x-axis at a constant speed, the movement amount Δx of the interference pattern may have a constant positive value first and a negative value later according to time or position. The time may correspond to the position of the transparent substrate 220, and the movement amount Δx of the interference pattern may correspond to an optical phase difference Ø₀(x1,x2). An accumulated optical phase difference Φ(xn) may be obtained by integrating a phase difference over distance. The accumulated optical phase difference Φ(xn) may correspond to an accumulated optical path difference. If a refractive index of the transparent substrate 220 is constant, the accumulated optical path difference may correspond to a thickness difference.

Since a transparent substrate monitoring apparatus according to an embodiment of the present invention employs a transmission-type interference optical system, the transparent substrate monitoring apparatus is not affected by vibration of the transparent substrate. Thus, even in the case that a transparent substrate monitoring apparatus is mounted on a transfer apparatus generating vibration, a spatial distribution of a relative optical phase difference and an optical phase difference may be stably measured.

According to a modified embodiment of the present invention, even in the case that a transparent electrode such as indium in oxide (ITO) is deposited on a transparent substrate, a phase difference of the ITO may be measured. Silicon oxide, silicon nitride, silicon, a conductive layer which light pass through, or a contaminant layer may be deposited on a transparent substrate. Even in this case, the present invention may be applied. The transparent substrate may be a glass substrate, a plastic substrate, a silicon substrate or a transparent film.

According to a modified embodiment of the present invention, an interval “a” between slits of the double slit may be varied. For example, a double slit having a different interval may replace a conventional double slit. Thus, a distance between a pair of measuring positions may be controlled. For example, as transfer speed of a transparent substrate increases, an interval “a” between the slits of the double slit may increase.

According to a modified embodiment of the present invention, a first position x1 may be disposed on a reference transparent substrate whose thickness and refractive index are already known, and a second position x2 may be disposed on a transparent substrate to be measured. Thus, an absolute optical phase difference or an absolute optical path difference may be calculated on the transparent substrate to be measured.

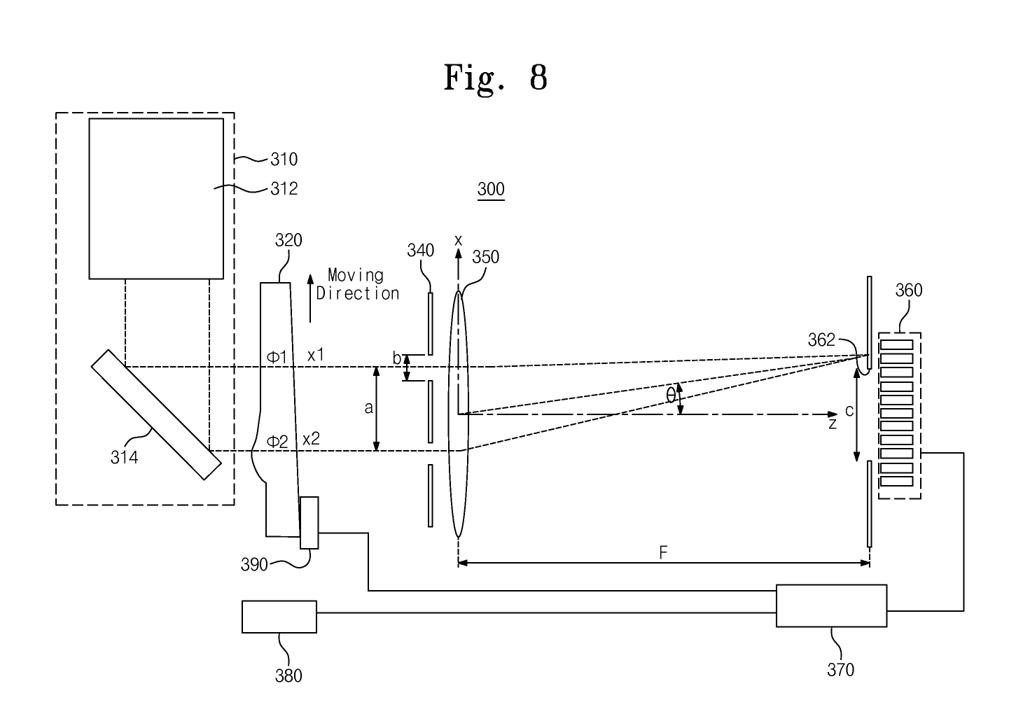

FIG. 8 illustrates a transparent substrate monitoring apparatus according to another embodiment of the present invention.

Referring to FIG. 8, a transparent substrate monitoring apparatus 300 includes a light emitting unit 310 irradiating light, a double slit 340 disposed on a plane defined by a first direction and a second direction intersecting a propagation direction of the light and including a first slit and a second slit spaced apart from each other in the first direction to allow the light to pass therethrough, an optical detection unit 360 measuring an interference pattern or position shift of the interference pattern formed on a screen plane by first light transmitting a first position of a transparent substrate 320 disposed between the light emitting unit 310 and the double slit 340 and passing through the first slit and second light transmitting a second position of the transparent substrate and passing through the second slit, and a signal processing unit 370 receiving a signal from the optical detection unit 360 to calculate an optical phase difference or an optical path difference caused by the first position and the second position.

The optical phase difference (Ø₀=Ø1−Ø2) may be a difference in phase between a phase Ø1 caused by a first position x1 and a phase Ø2 caused by a second position x2. The phase Ø1 caused by the first position x1 may be a function of thickness and refractive index of a transparent substrate.

The light emitting unit 310 may include a light source 312 and a reflection member 314. The reflection member 314 may change an optical path of output light of the light source 312.

According to a modified embodiment of the present invention, the reflection member 314 may provide a linear motion in the x-axis direction. In this case, the light source 312 and the transparent substrate 320 may be fixed. At this same time, the reflection member 314, the double slit 340, and the optical detection unit 360 may move in the x-axis direction. According to the linear motion of the reflection member 314, an optical phase difference or an optical path difference may be measured at different positions of the transparent substrate.

The optical detection unit 360 may be disposed at the focal point of a lens unit 350. In the case that the optical detection unit 360 is an optical sensor array, the optical sensor array may be disposed in an interval direction (x-axis direction) of a slit. In addition, an aperture 362 may be eliminated. The optical detection unit 360 may measure an interference pattern. Thus, the signal processing unit 370 may recognize the interference pattern and extract the movement amount Δx of the interference pattern.

Even in the case that the optical detection unit 360 is an optical sensor array, an aperture 362 may be disposed in front of the optical detection unit 360. The aperture 362 may remove an unnecessary pattern to measure only one pattern desired to be measured. Thus, the optical detection unit 360 may measure only an interference pattern in a region desired to be measured. For example, the aperture 362 may allow only a principal maximum pattern of an interference pattern to pass therethrough. Thus, the computation amount of the signal processing unit 370 may be reduced.

The signal processing unit 370 may control a driving unit 390. Thus, the driving unit 390 may move a transparent substrate at constant speed or stop the transparent substrate. The driving unit 390 may be a transfer device using a transfer roller, a transfer device using vacuum-absorbing, or a levitation transfer device.

A position sensor unit 380 may sense a transfer distance of the transparent substrate 320. The position sensor unit 380 may be an optical sensor or an ultrasonic sensor. An output signal of the position sensor unit 380 may be provided to the signal processing unit 370 to correct a measuring position.

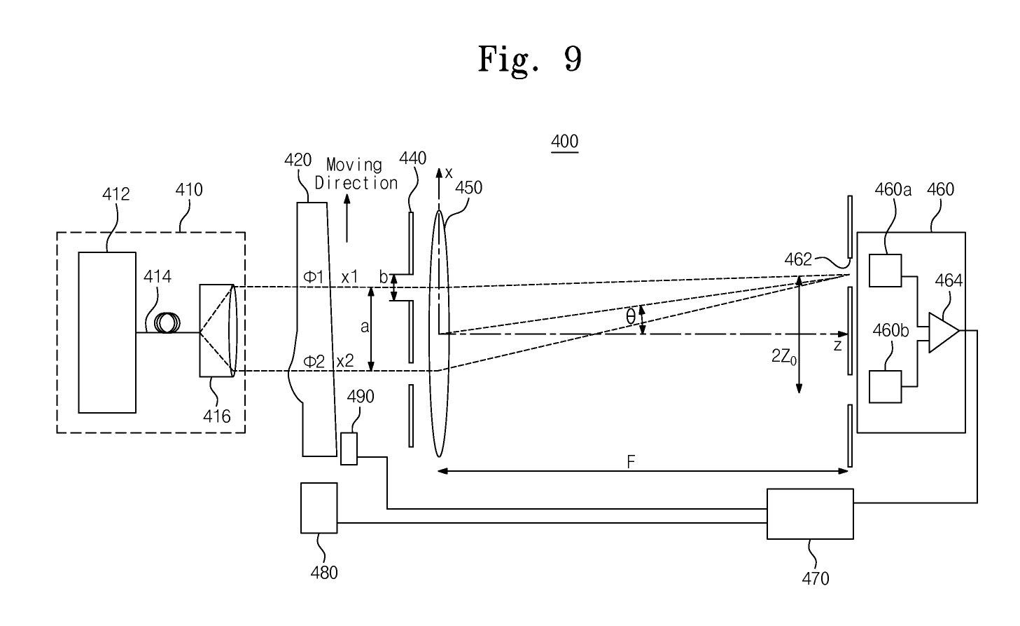

FIG. 9 a transparent substrate monitoring apparatus according to further another embodiment of the present invention.

Referring to FIG. 9, a transparent substrate monitoring apparatus 400 includes a light emitting unit 410 irradiating light, a double slit 440 disposed on a plane defined in a first direction and a second direction intersecting a propagation direction of incident light and including a first slit and a second slit spaced apart from each other in the first direction to allow the light to pass therethrough, an optical detection unit 460 measuring an interference pattern or position shift of the interference pattern formed on a screen plane by first light transmitting a first position x1 of a transparent substrate 420 disposed between the light emitting unit 410 and the double slit 440 and passing through the first slit and second light transmitting a second position x2 of the transparent substrate 420 and passing through the second slit, and a signal processing unit 470 receiving a signal from the optical detection unit 460 to calculate an optical phase difference or an optical path difference caused by the first position and the second position.

The light emitting unit 410 may include a light source 412, an optical fiber 414 receiving output light of the light source 412, and a collimation lens 416 converting light output from the optical fiber 414 to collimated light and providing the collimated light to the double slit 440.

The optical detection unit 460 may includes a first optical detection unit 460a and a second optical detection unit 460b. The first and second optical detection units 460a and 460b may be disposed behind a pair of apertures 462, respectively. The first and second optical detection units 460a and 460b may each detect the intensity of light passing through the aperture 462. The smaller the width of the aperture 462, the more desirable. However, if the width of the aperture 462 is too small, the amount of light passing through the aperture 462 may be reduced. The aperture 462 may extend in the y-axis direction. A distance 2Z₀ between the apertures may several times or tens of times the width of the aperture 462. An output signal of the first optical detection unit 460a and an output signal of the second optical detection unit 460b are provided as input signals of a differential amplifier 464. The differential amplifier 464 may amplify a difference between the output signals of the first and second optical detection units 460a and 460b and provide the amplified difference to the signal processing unit 470.

There is a first aperture at a distance of Z₀ from the center of the apertures. An angle of the first aperture is θ1. In addition, there is a second aperture at a distance of −Z₀ from the center of the apertures. An angle of the second aperture is −θ1. Accordingly, a difference between irradiances measured at the first aperture and the second aperture may be given by the Equations (6) and (7). The angle may be approximate to “θ1=Z₀/F”. In the figure, F represents a focal length of the lens unit 450. That is, the aperture 462 may be disposed at the focal point of the lens unit 450.

If there is no transparent substrate, an output signal of the differential amplifier 464 may be corrected to zero. If there is a phase difference caused by a transparent substrate, the output signal of the differential amplifier 464 may vary depending on the phase difference.

The Equations (6) to (8) may be used to detect the movement amount or a phase difference of a principal maximum pattern of an interference pattern. The distance 2Z₀ distance between the apertures may be smaller than width of the principal maximum pattern of the interference pattern.

The signal processing unit 470 may compute the movement amount or a phase difference of the principal maximum pattern of the interference pattern by using a predetermined algorithm.

According to a modified embodiment of the present invention, a single aperture may be disposed on the central axis of the lens unit 450. In this case, a single optical detection unit may be disposed behind the single aperture. The optical detection unit may measure the intensity of a principal maximum pattern depending on shift of central position of the principal maximum pattern. The movement amount of the principal maximum pattern may be extracted from only the intensity of the principal maximum pattern.

In addition, the signal processing unit 470 may control a driving unit 490. Thus, the driving unit 490 may move a transparent substrate at constant speed or stop the transparent substrate. The driving unit 490 may be a transfer device using a transfer roller, a transfer device using vacuum-absorbing, or a levitation transfer device.

A position sensor unit 480 may sense a transfer distance of the transparent substrate 420. The position sensor unit 480 may be an optical sensor or an ultrasonic sensor. An output signal of the position sensor unit 480 may be provided to the signal processing unit 470 to correct a measuring position.

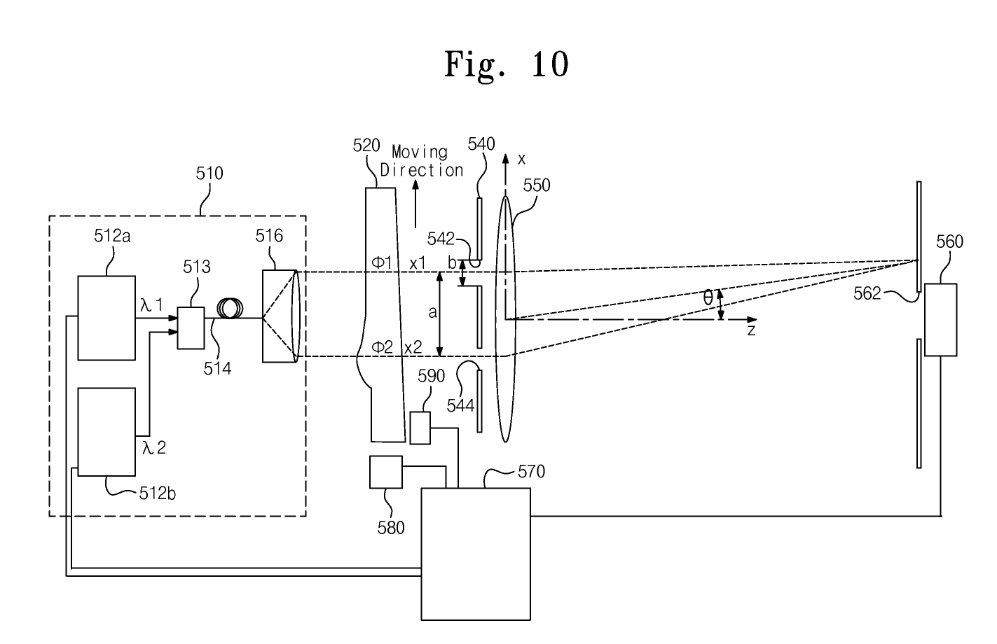

FIG. 10 a transparent substrate monitoring apparatus according to still another embodiment of the present invention.

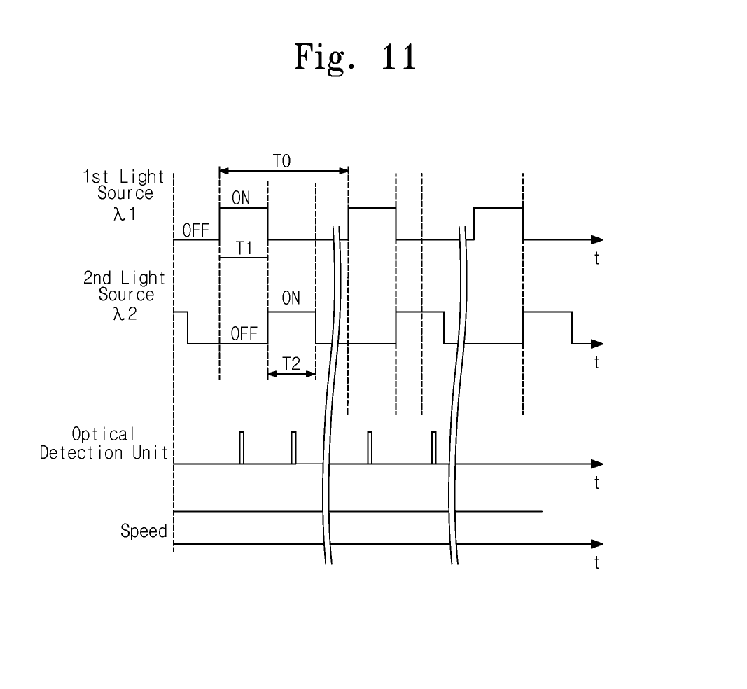

FIG. 11 is a timing diagram of the transparent substrate monitoring apparatus in FIG. 10.

Referring to FIGS. 10 and 11, a transparent substrate monitoring apparatus 500 a light emitting unit 510 irradiating light, a double slit 540 disposed on a plane defined in a first direction and a second direction intersecting a propagation direction of incident light and including a first slit 542 and a second slit 544 spaced apart from each other in the first direction to allow the light to pass therethrough, an optical detection unit 560 measuring an interference pattern or position shift of the interference pattern formed on a screen plane by first light transmitting a first position x1 of a transparent substrate 520 disposed between the light emitting unit 510 and the double slit 440 and passing through the first slit 542 and second light transmitting a second position x2 of the transparent substrate 520 and passing through the second slit 544, and a signal processing unit 570 receiving a signal from the optical detection unit 560 to calculate an optical phase difference or an optical path difference caused by the first position and the second position.

The light emitting unit 510 may include a first light source 512a irradiating light of first wavelength (λ1), a second light source 512b irradiating light of second wavelength (λ2) that is different from the first wavelength (λ1), a directional coupler 513 coupling an optical path of the first light source 512a with an optical path of the second light source 512b, and a parallel light lens 516 providing output light of the directional coupler 513 to the double slit 540.

Hereinafter, a method of identifying a thickness difference and a refractive index difference of the transparent substrate from an optical path difference (or optical phase difference) using two light sources 512a and 512b will now be described below in detail.

Ø₀ represents an optical phase difference between a phase Ø1 of the first position x1 and a phase Ø2 of the second position x2. The optical phase difference Ø₀ may be expressed as an optical path difference.

φ₀=(2π/λ)(ΔL) Equation (11)

In the Equation (11), λ represents a wavelength in vacuum of the first light source 512a or the second light source 512b and ΔL represents an optical path difference.

An optical path “L” is a function of a refractive index “n” and a thickness “1”. The optical path “L” may be divided into a refractive index and a thickness. For achieving this, there is a need for measuring the optical path difference ΔL to two different wavelengths.

An optical path L(x,λ) may be expressed by a refractive index n(x,λ) and a thickness 1(x) of the transparent substrate. The refractive index n(x,λ) is a function of position x and wavelength λ of the transparent substrate, and a physical thickness 1(x) of the transparent substrate is a function of position x.

A refractive index of a transparent substrate may be approximate to “n(x,λ)=n₀+g(λ)+w(x)” (n₀ being a representative value of refractive index of the transparent substrate, g(λ) being a refractive index depending on a wavelength, and w(x) being a refractive index depending on a position).

A physical thickness of the transparent substrate is a function of position and may be approximate to “1(x)=1₀+δ(x)” (1₀ being a fixed thickness and δ(x) being a relative thickness varying depending on position). The optical path L(x,λ) may be approximate to the Equation (12) below.

L(x,λ)≈l₀[n₀+g(λ)+w(x)]+[n₀+g(λ)]δ(x) Equation (12)

Optical paths at two adjacent positions x1 and x2 and at a first wavelength λ1 may be given by the Equation (13) below.

L(x1,λ1)≈l₀[n₀+g(λ1)+w(x1)]+[n₀+g(λ1)]δ(x1)

L(x2,λ1)≈l₀[n₀+g(λ1)+w(x2)]+[n₀+g(λ1)]δ(x2)

In addition, optical paths at two adjacent positions x1 and x2 and at a second wavelength λ2 may be given by the Equation (14) below.

L(x1,λ2)≈l₀[n₀+g(λ2)+w(x1)]+[n₀+g(λ2)]δ(x1)

L(x2,λ2)≈l₀[n₀+g(λ2)+w(x2)]+[n₀+g(λ2)]δ(x2)

An optical path difference at two positions and at the first wavelength 21 may be given by the Equation (15) below.

$$\begin{matrix}Δ L ( λ 1 ) = L ( x 1 , λ 1 ) - L ( x 2 , λ 1 ) \\ = {I}_{0} [ w ( x 1 ) - w ( x 2 ) ] + [ {n}_{0} + g ( λ 1 ) ] [ δ ( x 1 ) - δ ( x 2 ) ]\end{matrix} \qquad Equation ( 15 )$$

In addition, an optical path difference at two positions and at the second wavelength λ2 may be given by the Equation (16) below.

$$\begin{matrix}Δ L ( λ 2 ) = L ( x 1 , λ 2 ) - L ( x 2 , λ 2 ) \\ = {I}_{0} [ w ( x 1 ) - w ( x 2 ) ] + [ {n}_{0} + g ( λ 2 ) ] [ δ ( x 1 ) - δ ( x 2 ) ]\end{matrix} \qquad Equation ( 16 )$$

Accordingly, [δ(x1)−δ(x2)] may be given by the Equation (17) below.

[δ(x1)−δ(x2)]=(ΔL(λ1)−ΔL(λ2))/(g(λ1)−g(λ2)) Equation (17)

In addition, 1₀ [w(x1)−w(x2)] may be given by the Equation (18) below.

l₀[w(x1)−w(x2)]=([n₀+g(λ1)]ΔL(λ2)−[n₀+g(λ2)]ΔL(λ1))/(g(λ1)−g(λ2)) Equation (18)

That is, the thickness difference (δ(x1)−δ(x2)) and the refractive index difference ([w(x1)−w(x2)]) depending on position may be obtained.

Accordingly, a thickness difference at a certain position xn may be given with respect to a reference position x1 by the Equation (19) below.

δ(x1)−δ(xn)=[δ(x1)−δ(x2)]+[δ(x2)−δ(x3)] . . . +[δ(xn−1)−δ(xn)] Equation (19)

In addition, a refractive index difference at the certain position xn may be given with respect to the reference position x1 by the Equation (20) below.

w(x1)−w(xn)=[w(x1)−w(x2)]+[w(x2)−w(x3)] . . . +[w(xn−1)−w(xn)] Equation (20)

As a result, a thickness difference distribution and a refractive index difference distribution may be obtained according to a scanning position.

A first wavelength of the first light source 512a may range from about 700 nm to about 2000 nm. A second wavelength of the second light source 512b is different from the first wavelength of the first light source 512a and may range from about 700 nm to about 2000 nm Each of the first and second light sources 512a and 512b may be a diode. Specifically, each of the first and second light sources 512a and 512b may be a superluminescent diode (SLD).

The directional coupler 513 may receive output light of the first light source 512a through its first input port and receive output light of the second light source 512b through its second input port. The direction coupler 513 may provide the output lights of the first and second light sources 512a and 512b through its output port. The output port of the directional coupler 513 may be provided to an optical fiber 514. Light passing through the optical fiber 514 may be provided to the parallel light lens 516. The parallel light lens 516 may convert output light of the optical fiber 514 to parallel light.

The transparent substrate 520 may move in the x-axis direction at constant speed. The driving unit 590 may transfer the transparent substrate 520 at constant speed.

The first light source 512a may periodically operate for a time T1. The operating time T1 of the first light source 512a may be much shorter than a period T0. The second light source 512b may periodically operate for a time T2. The operating time T2 of the second light source 512b may be much shorter than the period T0. The operating time T1 of the first light source 512a may not overlap the operating time T2 of the second light source 512b. Thus, a first interference pattern may be formed on a screen plane by the first light source 512 for the first operating time T1. Next, a second interference pattern may be formed on the screen plane by the second light source 512b for the second operating time T2.

A measuring time of an interference pattern is much shorter than the period T0 to measure characteristics of the transparent substrate 520. A pulse operating frequency of the first light source 512a and the second light source 512b may be in the MHz level. Accordingly, the moving distance of the transparent substrate 520 is negligible for the first operating time T1 and the second operating time T2.

The optical detection unit 560 may measure the movement amount Δx(λ1) of a first interference pattern for the first operating time T1. In addition, the optical detection unit 560 may measure the movement amount Δx(λ2) of a second interference pattern for the second operating time T2. The optical detection unit may be a position sensitive detector. An aperture 562 may be disposed in front of the optical detection unit to measure only a principal maximum pattern.

A position sensor unit 580 may sense a transfer distance of the transparent substrate 520. The position sensor unit 580 may be an optical sensor or an ultrasonic sensor. An output signal of the position sensor unit 580 may be provided to the signal processing unit 570 to correct a measuring position.

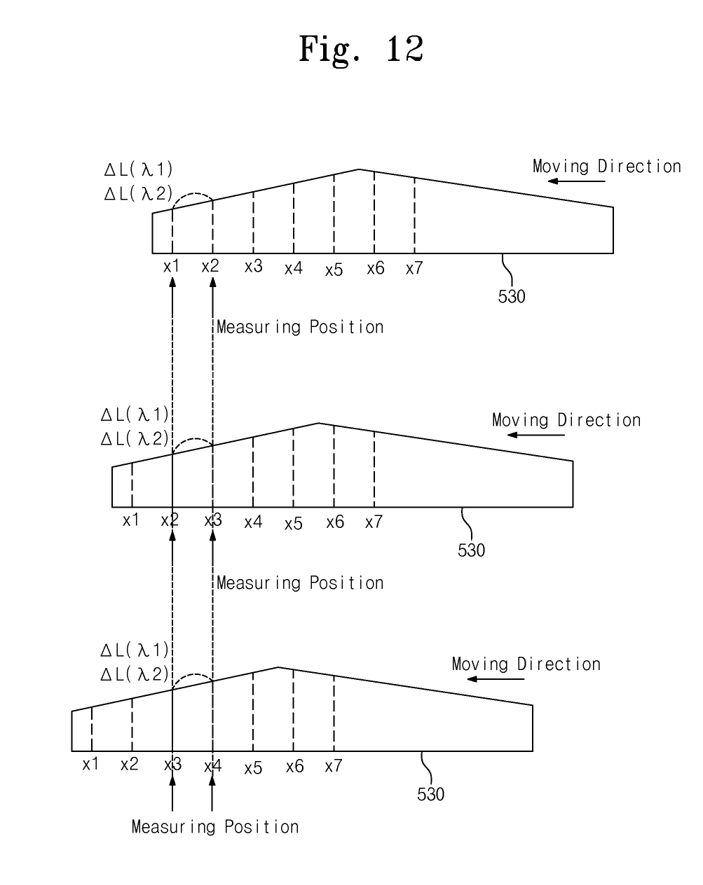

FIG. 12 illustrates a transparent substrate monitoring method according to an embodiment of the present invention.

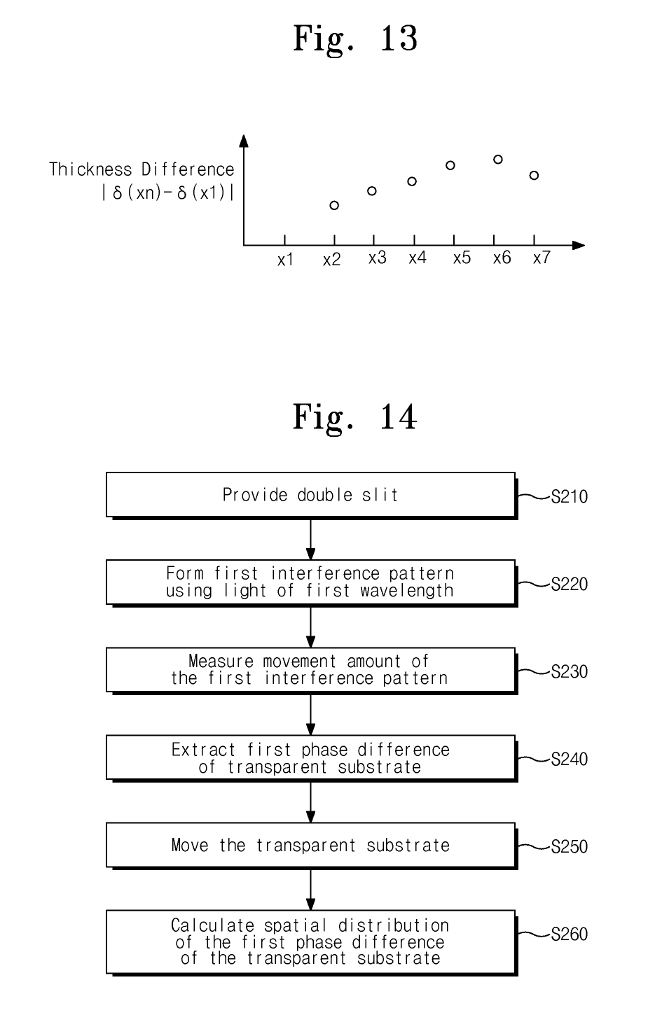

FIG. 13 shows a result obtained using the method in FIG. 12.

Referring to FIGS. 12 and 13, the movement amount Δx(λ1) of a first interference pattern may be expressed as an optical phase difference Ø₀(λ1) of the first interference pattern, and the movement amount Δx(λ2) of a second interference pattern may be expressed as an optical phase difference Ø₀(λ2) of the second interference pattern (k(λ1) being a wave number, b being width of a slit, and F being a focal length of a lens unit 550). In this case, the movement amount Δx(λ1) of the first interference pattern and the movement amount Δx(λ2) of the second interference pattern may be expressed by the Equation (21) below.

$$Δ x ( λ 1 ) = \frac{F {φ}_{0} ( λ 1 )}{k ( λ 1 ) a} = F Δ L ( λ 1 ) / a \\ Δ x ( λ 2 ) = \frac{F {φ}_{0} ( λ 2 )}{k ( λ 2 ) a} = F Δ L ( λ 2 ) / a \qquad Equation ( 21 )$$

A signal processing unit 570 may extract a thickness difference (δ(x1)−δ(x2)) and a refractive index difference ([w(x1)−w(x2)]) depending on a position by using the above-mentioned algorithm.

The signal processing unit 570 may extract an optical path difference ΔL(λ1) with respect to a first position and a second position and with respect to a first wavelength λ1 by using the movement amount Δx(λ1) of the interference pattern.

The signal processing unit 570 may extract an optical path difference ΔL(λ2) with respect to the first position and the second position and with respect to a second wavelength λ2 by using the movement amount Δx(λ2) of the interference pattern. The signal processing unit 570 may extract the thickness difference (δ(x1)−δ(x2)) and the refractive index difference ([w(x1)−w(x2)]) by using the optical path differences ΔL(λ1) and ΔL(λ2).

Thereafter, a transparent substrate 530 is transferred. Thus, the above operations may be repeatedly performed at the second position x2 and a third position x3 to obtain a thickness difference (δ(x1)−δ(x3)) of the third position x3 with respect to a reference position x1 and a refractive index difference (w(x1)−w(x3)) of the third position x3 with respect to the reference position x1.

Thereafter, a transparent substrate 530 is transferred. Thus, the above operations may be repeatedly performed at the third x3 and a fourth position x4 to obtain a thickness difference (δ(x1)−δ(x4)) of the fourth position x4 with respect to the reference position x1 and a refractive index difference (w(x1)−w(x4)) of the fourth position x4 with respect to the reference position x1.

FIG. 14 is a flowchart illustrating a transparent substrate monitoring method according to an embodiment of the present invention.

Referring to FIGS. 6 and 7 and FIG. 14, a transparent substrate monitoring method includes providing a double slit (S210). The double slit is disposed on a plane defined in a first direction and a second direction intersecting a propagation direction of incident light and includes a first slit and a second slit spaced apart from each other in the first direction to allow the light to pass therethrough.

Light of first wavelength, with coherency, successively passes through a transparent substrate and the double slit to form a first interference pattern (S220).

The first interference pattern is formed on a screen plane by first light transmitting a first position of a transparent substrate disposed in front of the double slit and passing through the first slit and second light transmitting a second position of the transparent substrate and passing through the second slit. The movement amount or position of the first interference pattern may be measured using an optical detection unit (S230).

A first phase difference caused by the transparent substrate may be extracted from the movement amount of the first interference pattern with the light of first wavelength or a first phase difference caused by the transparent substrate may be analyzed by the position of the first interference pattern (S240).

The transparent substrate may move by a slit interval of the double slit in a direction of the slit interval or the slit separation due to a driving unit (S250).

The first phase differences measured at previous positions may be summed Thus, a spatial distribution of the first phase difference of the transparent substrate may be calculated (S260). An accumulated optical phase difference Φ may be expressed by the sum of the first phase difference measured at the previously position. Thus, the spatial distribution of the accumulated optical phase difference with respect to a reference position may be calculated.

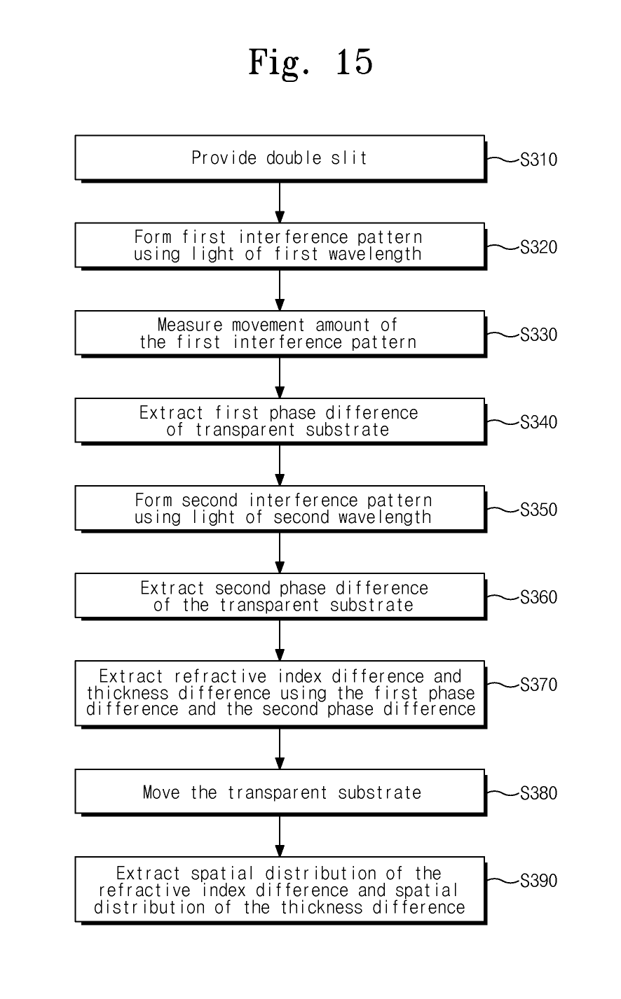

FIG. 15 is a flowchart illustrating a transparent substrate monitoring method according to another embodiment of the present invention.

Referring to FIGS. 10 to 13 and FIG. 15, a transparent substrate monitoring method includes providing a double slit (S310). The double slit is disposed on a plane defined in a first direction and a second direction intersecting a propagation direction of incident light and includes a first slit and a second slit spaced apart from each other in the first direction to allow the light to pass therethrough.

Light of first wavelength, with coherency, successively passes through a transparent substrate and the double slit to form a first interference pattern (S320).

The first interference pattern is formed on a screen plane by first light transmitting a first position of a transparent substrate disposed in front of the double slit and passing through the first slit and second light transmitting a second position of the transparent substrate and passing through the second slit. The movement amount or position of the first interference pattern may be measured using an optical detection unit (S330).

A first phase difference caused by the transparent substrate may be extracted from the movement amount of the first interference pattern with the light of first wavelength or an first phase difference caused by the transparent substrate may be analyzed by the position of the first interference pattern (S340).

Light of second wavelength, with coherency, successively passes through the transparent substrate and the double slit to form a second interference pattern (S350).

The movement amount or position of the second interference pattern by the light of second wavelength may be measured. A signal processing unit may calculate a second phase difference caused by the transparent substrate using the movement amount or position of the second interference pattern (S360).

A refractive index difference and a thickness difference may be extracted using the first phase difference and the second phase difference (S370).

The transparent substrate may move by a slit interval of the double slit in a direction of the slit interval due to a driving unit (S380).

A spatial distribution of the refractive index difference may be extracted by summing the refractive index measured at a previous position, and a spatial distribution of the thickness difference may be extracted by summing the thickness difference measured at the previous position (S390).

A lens may be mounted behind the double slit to have a focal point on the screen plane. An aperture may be provided on the screen plane to allow only a principal maximum pattern among the first interference pattern to pass therethrough.

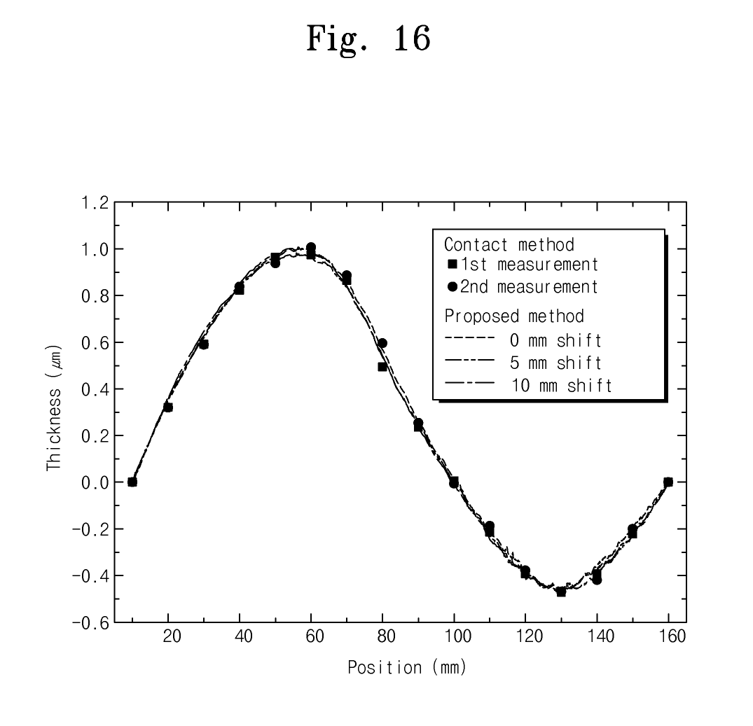

FIG. 16 is a graph showing an optical path difference measuring result according to an embodiment of the present invention.

Referring to FIG. 16, a measuring range is 150 mm, movement speed of a glass substrate is 250 mm/sec, and a data acquisition interval (interval of a double slit) is 0.1 mm.

A square is a value measured through a contact measurement method, and a solid line is a value measured according to an embodiment of the present invention. Overall, there is an optical path difference in the form of sine wave. A constant value was subtracted from a contact measurement result such that the contact measurement result matches a measurement result according to the present invention. The measurement according to the present invention was done three times while moving a substrate by 0 mm, 5 mm, and 10 mm orthogonal to a moving direction the substrate. Thus, it could be understood that the contact measurement result (circle and square) measured twice matches the measurement result (solid line) according to the present invention. In addition, an optical path difference was expressed by a thickness difference under the assumption that a refractive index of the glass substrate is constant. The thickness of the glass substrate varies in the form of sine wave while having a period of about 200 millimeters and the amplitude of about 1 micrometer. A thickness resolution according to an embodiment of the present invention may be less than several nanometers.

By the above-described thickness variation measuring apparatus and thickness variation measuring method, thickness variation of a measurement target can be precisely measured and an aspect of thickness variation on the entire surface of the measurement target can be measured. A transparent substrate monitoring apparatus according to an embodiment of the present invention can measure an optical phase difference that is resistant to vibration. A transparent substrate monitoring apparatus according to an embodiment of the present invention can separate an optical phase difference into refractive index and thickness by using two wavelength.

Although the present invention has been described in connection with the embodiment of the present invention illustrated in the accompanying drawings, it is not limited thereto. It will be apparent to those skilled in the art that various substitutions, modifications and changes may be made without departing from the scope and spirit of the present invention

What is claimed is:

1. A transparent substrate monitoring apparatus comprising:
a light emitting unit emitting light;
a double slit disposed on a plane defined in a first direction and a second direction intersecting a propagation direction of incident light and includes a first slit and a second slit spaced apart from each other in the first direction to allow the light to pass therethrough;
an optical detection unit measuring an intensity profile or position of an interference pattern formed on a screen plane by first light transmitting a first position of a transparent substrate disposed between the light emitting unit and the double slit and passing through the first slit and second light transmitting a second position of the transparent substrate and passing through the second slit; and
a signal processing unit receiving a signal from the optical detection unit to calculate an optical phase difference or an optical path difference caused by the first position and the second position of the transparent substrate.

2. The transparent substrate monitoring apparatus of claim 1, wherein the signal processing unit calculates the optical path difference using a moving position of the interference pattern in the first direction.

3. The transparent substrate monitoring apparatus of claim 1, wherein the transparent substrate which moves in the first direction is a glass substrate.

4. The transparent substrate monitoring apparatus of claim 1, wherein the optical detection unit includes a position sensitive detector,
which further comprises an aperture disposed in front of the optical detection unit to allow a principal maximum pattern of the interference pattern to pass therethrough, and
wherein the position sensitive detector outputs a center position of the principal maximum pattern.

5. The transparent substrate monitoring apparatus of claim 1, further comprising:
a first aperture and a second aperture disposed in front of the optical detection unit and spaced apart from each other in the first direction,
wherein the optical detection unit includes a first optical detection unit disposed behind the first aperture and a second detection unit disposed behind the second aperture, and
wherein an interval between the first aperture and the second aperture is smaller than the width of a principal maximum pattern of the interference pattern.

6. The transparent substrate monitoring apparatus of claim 1, further comprising:
an aperture disposed in front of the optical detection unit,
wherein the optical detection unit includes an optical sensor array disposed behind the aperture and arranged in the first direction.

7. The transparent substrate monitoring apparatus of claim 1, further comprising:
a lens unit disposed between the double slit and the optical detection unit,
wherein the optical detection unit is disposed at a focal point of the lens unit.

8. The transparent substrate monitoring apparatus of claim 1, wherein the light emitting unit comprises:
a light source; and
a reflection member changing an optical path of output light of the light source and providing the optical-path-changed light to the double slit.

9. The transparent substrate monitoring apparatus of claim 1, wherein the light emitting unit comprises:
a light source;
an optical fiber receiving output light of the light source; and
a collimation lens converting light output from the optical fiber to collimated light and providing the collimated light to the double slit.

10. The transparent substrate monitoring apparatus of claim 1, wherein the light emitting unit comprises:
a first light source irradiating light of first wavelength;
a second light source irradiating light of second wavelength differing from the first wavelength;
a directional coupler coupling an optical path of the first light source with an optical path of the second light source; and
a collimation lens providing output light of the directional coupler to the double slit.

11. The transparent substrate monitoring apparatus of claim 10, wherein the first light source and the second light source operate in a pulse mode, and
wherein the first light source and the second light source sequentially provide output lights to the double slit.

12. A transparent substrate monitoring method comprising:
providing a double slit disposed on a plane defined in a first direction and a second direction intersecting a propagation of incident light and including a first slit and a second slit spaced apart from each other in the first direction to allow the light to pass therethrough;
forming a first interference pattern by letting light of first wavelength with coherency successively pass through a transparent substrate and the double slit;
measuring the position of the first interference pattern formed on a screen plane by first light transmitting a first position of a transparent substrate disposed in front of the double slit and passing through the first slit and second light transmitting a second position of the transparent substrate and passing through the second slit; and
measuring a first phase difference caused by the transparent substrate by analyzing the position of the first interference pattern with the light of first wavelength.

13. The transparent substrate monitoring method of claim 12, further comprising:
moving the transparent substrate by the slit interval of the double slit in the direction of the slit separation.

14. The transparent substrate monitoring method of claim 12, further comprising:
calculating a spatial distribution of a first accumulated phase difference of the transparent substrate by summing the first phase differences measured at previous positions.

15. The transparent substrate monitoring method of claim 12, further comprising:
forming a second interference pattern by letting light of second wavelength with coherency successively pass through the transparent substrate and the double slit;
measuring a second phase difference caused by the transparent substrate by measuring the position of the second interference pattern with the light of second wavelength; and
extracting a refractive index difference and a thickness difference between a first position and a second position of the substrate using the first phase difference and the second phase difference.

16. The transparent substrate monitoring method of claim 15, further comprising:
moving the transparent substrate by a slit interval of the double slit in a direction of the slit separation.

17. The transparent substrate monitoring method of claim 16, further comprising:
extracting a spatial distribution of refractive index difference by summing the refractive index differences measured at previous positions and extracting a spatial distribution of thickness difference by summing the thickness differences measured at the previous positions.

18. The transparent substrate monitoring method of claim 12, further comprising:
mounting a lens behind the double slit to have a focal point on the screen plane.

19. The transparent substrate monitoring method of claim 12, further comprising:
providing an aperture on the screen plane to allow only a principal maximum pattern among the first interference pattern to pass therethrough.

20. An optical phase difference measuring apparatus comprising:
a light emitting unit emitting light;
a double slit disposed on a plane defined in a first direction and a second direction intersecting a propagation of incident light and including a first slit and a second slit spaced apart from each other in the first direction to allow the light to pass therethrough;
an optical detection unit measuring an intensity profile or position of an interference pattern formed on a screen plane by first light transmitting a first position of a measurement target disposed between the light emitting unit and the double slit and passing through the first slit and second light transmitting a second position of the measurement target and passing through the second slit; and
a signal processing unit receiving a signal from the optical detection unit to calculate an optical phase difference of light rays passing through the first position and the second position of the transparent substrate.
